(19) United States
(12) Patent Application Publication
(10) Pub. No.: US 2026/0135389 A1
(43) Pub. Date: May 14, 2026

(54) HYBRID PRIME POWER ENERGY SYSTEM

(71) Applicant: Alliance North America, Inc, Henderson, NV (US)

(72) Inventors: Jeremy A. Goddard, Henderson, NV (US); Travis Waineo, Henderson, NV (US); Michael Yin, Henderson, NV (US); Gregory McFadden, Las Vegas, NV (US)

(21) Appl. No.: 19/382,540

(22) Filed: Nov. 7, 2025

Related U.S. Application Data
(60) Provisional application No. 63/718,290, filed on Nov. 8, 2024.

(51) Int. Cl. H02J 3/32; H02J 3/38; H02J 7/00

(52) U.S. Cl. CPC H02J 3/32; H02J 3/38; H02J 7/575; H02J 2101/24; H02J 2101/28

(57) ABSTRACT

A hybrid energy system is configured to carry a power load for a generator configured to output an AC signal. The hybrid energy system includes a plurality of battery banks, and a renewable energy source. The plurality of battery banks includes a low cycle life battery and a high cycle life battery. When the renewable energy source is outputting more power than required by a load, the access energy is used to recharge the plurality of battery banks. The low cycle life battery is only recharged once a day by the renewable energy source. The high cycle life battery can be recharged by both the renewable energy source and the generator.

### CROSS REFERENCE TO RELATED APPLICATION

The present application claims the benefit of U.S. provisional application Ser. No. 63/718,290 filed Nov. 8, 2024, which is hereby incorporated herein by reference in its entirety.

### FIELD OF THE INVENTION

The present invention is directed to battery systems, power generation, system controls, and in particular to battery storage systems in combination with generators in mobile and stationary applications.

### BACKGROUND OF THE INVENTION

Generators are often driven by engines, such as diesel engines, and other engines using a variety of fuels, e.g., propane, natural gas, gasoline, biodiesel, and hydrogen. When properly loaded, a diesel engine provides an efficient driver for a generator, when lightly loaded, diesel engines are susceptible to wet stacking (i.e., when unburnt diesel fuel passes into the diesel exhaust system and produces an oily residue). Wet stacking happens when a diesel engine is running at a low percentage or proportion of its capacity. For example, a diesel engine coupled to a generator is susceptible to wet stacking when the generator it is driving has no load or only a minimal load coupled to it; in addition, the generator operates less efficiently (more fuel is consumed per kwh produced versus an optimally loaded generator). When the generator is operating with no load or only a minimal load, the diesel engine is operating in an inefficient manner, resulting in the risk of wet stacking because the diesel engine is not at a proper operating temperature (allowing unburnt fuel to escape into the diesel exhaust system). Diesel engines are most efficient when they are running at a sufficient percentage or proportion of their full capacity. When a diesel engine is running under a sufficient load, the diesel engine can run at an optimum operating temperature. Generators used to power electrical equipment typically see variable loads through their normal usage intervals. To aid in the prevention of wet stacking of diesel engines coupled to generators, dummy loads or load banks, and/or batteries can be applied to their generators. The load banks or batteries can provide a load on the generator that to help prevent wet stacking of the generator's diesel engine.

### SUMMARY OF THE INVENTION

Embodiments of the present invention provide a system for managing an operational environment of an engine-driven generator. Example engines include a variety of fuel sources, for example, diesel, propane, natural gas, gasoline, biodiesel, and hydrogen. A hybrid energy system improves the efficiency of an engine-powered generator by running the generator at its optimal load and reducing the generator's run time by storing unused power, or power the generator is capable of producing that is more than the load requires, in a battery or other similar energy storage technology. The hybrid energy system maximizes system efficiency and battery life by using batteries of multiple chemistries, for example, using a battery with a longer or larger battery cycle life in combination with a battery with a shorter or smaller battery cycle life. An exemplary hybrid energy system comprises a pair of batteries: a battery with a longer battery cycle life along with a battery with a shorter battery cycle life. As discussed herein, a battery with a long battery cycle life may be referred to as a “long life cycle battery” or a “high life cycle battery,” while a battery with a shorter battery cycle life may be referred to as a “short life cycle battery” or a “low life cycle battery.” In one embodiment, the battery with the short battery cycle life (the low life cycle battery) performs an energy storge function for renewable power sources such as photovoltaic (PV) or wind while the battery with the long battery cycle life (the high life cycle battery) performs a peak saving function for when the system is under high load and/or renewable energy is not available. The system maximizes efficiency and reduces charge/discharge cycles by prioritizing distribution of renewable power to the load, then outputting power to the load from the high life cycle battery, and then finally outputting power to the load from the low life cycle battery. The system also integrates non-renewable energy sources such as but not limited to diesel generators. The generator is configured to charge the high life cycle battery at a high charge rate so as to maximize the load of the generator as it runs maximizing generator efficiency and avoiding wet stacking. Finally, the system includes methods (e.g., computer implemented algorithms) that preserve the life of the low lifecycle batteries by restricting the charge rate and/or enabling non-renewable power generation based on temperature, load, number of charge/discharge cycles, and specific battery characteristics. The hybrid energy system includes a plurality of battery banks including a high life cycle battery and a low life cycle battery. In one embodiment, the hybrid energy system includes a high life cycle battery bank of batteries with longer battery life cycles and a low life cycle battery bank of batteries with shorter battery life cycles. The low life cycle battery is recharged, for example, once each day using a renewable energy source, such as a photovoltaic source, while the high life cycle battery is recharged as needed (when there is no renewable energy source) by an engine/generator. The hybrid energy system powers a load while the engine/generator is powered down. The power output from the engine/generator is converted to DC power by an AC/DC converter. The DC power is output by the hybrid energy system directly to a DC load.

In an aspect of the present invention, the hybrid energy system is positioned upon a trailer or truck bed that also holds the engine/generator. In another aspect of the present invention, the engine/generator and the hybrid energy system are combined in a unified body (i.e., an “all-in-one” body rather than two separate bodies that are coupled) that may be positioned upon a trailer or truck bed or upon some other surface.

In a further aspect of the present invention, an external battery system is coupled to the DC bus via a DC bus interface. The external battery system is configured to provide DC power to the DC bus and/or to receive DC power from the DC bus via the DC bus interface.

In a further aspect of the present invention, an external generator is coupled to the DC bus via a DC bus interface and/or an AC bus via an AC bus interface. The external generator is configured to provide AC power to the AC bus via the AC bus interface and/or provide DC power to the DC bus via the DC bus interface.

In yet another aspect of the present invention, the hybrid energy system is configured to work with any fuel-type generator, such as, propane, natural gas, gasoline, ethanol, diesel, biodiesel, or hydrogen.

In a further aspect of the present invention, the hybrid energy system is configured to interface with, and to function with, a DC generator by replacing the AC/DC converter with a DC/DC converter. The DC/DC converter in this aspect would not be required if the DC generator can output a DC voltage that matches the DC bus. In this configuration, there are only two converters (i.e., a DC/DC converter for the battery and a DC/AC converter to the AC outlet interface). The AC/DC converter has been replaced with the DC generator.

In another aspect of the present invention, the controller is configured to control the recharging of the battery bank such that the generator, when running, operates at an optimal and/or full load. The controller is configured to control the discharge of the battery bank, such that an operational run time of the generator is minimized.

In an aspect of the present invention, an exemplary hybrid energy system includes a generator, a first energy source, a plurality of battery banks, an AC/DC converter, and a controller. The generator outputs a first AC signal. The controller controls the charging and discharging of the plurality of battery banks. The first energy source outputs a first DC signal to a first DC bus of a plurality of DC buses. The AC/DC converter receives and converts the first AC signal from the generator into a second DC signal. The AC/DC converter outputs the second DC signal to a second DC bus of the plurality of DC buses. The plurality of battery banks includes a first battery bank and a second battery bank. The first battery bank outputs a third DC signal. The second battery bank outputs a fourth DC signal. The third DC signal is output to the first DC bus. When the generator is not outputting the first AC signal, at least one of the first battery bank and the second battery bank are configured to output the third DC signal and the fourth DC signal to the load, respectively. The controller is configured to control the recharging of the plurality of battery banks. The controller is operable to only recharge the first battery bank a selected quantity of times in a twenty-four-hour period. The controller is operable to recharge the second battery bank selectively using at least one of the renewable energy source and the generator.

In another aspect of the present invention, a hybrid energy system configured to carry a power load for a generator configured to output a first AC signal includes an energy source, a first DC/DC converter, a first battery bank and a second battery bank, an AC/DC converter, and a controller. The energy source outputs a first DC signal to the first DC/DC converter, which is configured to output a second DC signal to a first DC bus. The first DC bus is coupled to the first battery bank and the second DC/DC converter. The first battery bank selectively outputs a fourth DC signal. The AC/DC converter receives and converts the first AC signal from the generator into a third DC signal. The AC/DC converter outputs the third DC signal to a second DC bus. The second DC/DC converter and the second battery bank are coupled to the second DC bus. The second DC bus is coupled to a load. The second battery bank is configured to selectively output a fifth DC signal. The controller selectively controls the first battery bank and the second battery bank, such that when the generator is not outputting the first AC signal, at least one of the first battery bank and the second battery bank outputs the fourth DC signal and the fifth DC signal to the load, respectively. The controller controls the recharging of the second battery bank selectively using at least one of the energy source and the generator. The controller also controls the recharging of the first battery bank such that the first battery bank is only recharged once during a given time period. The first battery bank is selectively recharged using the energy source.

In a further aspect of the present invention, the first energy source is a renewable energy source. The first energy source comprises at least one of a photovoltaic generator, a wind-driven generator, and a water-driven generator. The first battery bank is a battery with a short battery cycle life, and the second battery bank is a battery with a long battery cycle life, such that the battery cycle life of the first battery is shorter than the battery cycle life of the second battery.

In another aspect of the present invention, the controller is operable to shut down the generator and power the load with the second battery bank whenever a charge level of the second battery bank is above a charge threshold level. The controller is operable to shut down the generator and power the load with the first battery bank while a charge level of the first battery bank is above a charge threshold level.

In yet another aspect of the present invention, the first battery bank comprises a charge capacity larger than a charge capacity of the second battery bank.

In a further aspect of the present invention, the controller is operable to control the recharging of the first battery bank and the second battery bank using (i) an energy source mode where while the generator is powered down and the load is powered by the energy source, when the energy source is outputting more power than required by the load, the energy source also recharges the first battery bank once in a given period of time and then recharges the second battery bank thereafter, and (ii) a generator mode where while powering the load with the generator, when the generator is outputting more power than required by the load, the generator also recharges the second battery bank.

These and other objects, advantages, purposes, and features of the present invention will become apparent upon review of the following specification in conjunction with the drawings.

### BRIEF DESCRIPTION OF THE DRAWINGS

FIG. 1A is a block diagram illustrating an exemplary hybrid energy system with multiple batteries and generator coupling via converters to a DC bus in accordance with the present invention;

FIG. 1B is a block diagram illustrating another exemplary hybrid energy system with multiple batteries and generator coupling via converters to DC buses in accordance with the present invention;

FIG. 2 is a perspective view of an exemplary hybrid energy system arranged alongside a generator and illustrating a load output interface in accordance with the present invention;

FIG. 3 is an opposite side perspective view of the hybrid energy system and generator of FIG. 2 and illustrating an additional load output interface;

FIG. 4 is a perspective view of the hybrid energy system and generator of FIG. 2 and illustrating an accessory outlet post in accordance with the present invention;

FIG. 5A is a view of an exemplary solar panel array or assembly connected via a DC/DC converter for coupling to an exemplary hybrid energy system in accordance with the present invention;

FIG. 5B is a view of the hybrid energy system of FIG. 6A positioned upon a trailer and integrated with a solar panel array in accordance with the present invention;

FIG. 6A is a perspective view of a variety of hybrid energy system and generator configurations in accordance with the present invention;

FIG. 6B is a block diagram of a hybrid energy system and generator arranged together within a unitary housing for stationary operation in accordance with the present invention;

FIG. 6C is a block diagram of the hybrid energy system and generator of FIG. 6C arranged on a trailer in accordance with the present invention;

FIG. 6D is a block diagram of an exemplary hybrid energy system and generator arranged for stationary operation in accordance with the present invention; and

FIG. 7 is a block diagram of an exemplary hybrid energy system and generator arranged in parallel with a plurality of hybrid energy systems in accordance with the present invention.

### DESCRIPTION OF THE PREFERRED EMBODIMENTS

Referring to the drawings and the illustrative embodiments depicted therein, a hybrid energy system provides for the elimination or reduction of loading issues on engine-driven generators. Such engines may be powered by a variety of fuels, for example, diesel, propane, natural gas, gasoline, biodiesel, and hydrogen. The engine/generators include, for example, exemplary diesel engine driven generators, such as, for example, EPA Tier 4F certified or other similarly compliant diesel engine driven mobile generators (as well as Stage 5 or higher). The hybrid energy system also provides for the powering down of the diesel engine driven generators while the hybrid energy system provides power to a load. Exemplary hybrid energy systems maximize system efficiency and battery life by using batteries of multiple chemistries, that for example, combine a larger capacity battery with a low battery cycle life (which may be referred to as a “low cycle life battery”) with a smaller capacity battery with a high battery cycle life (which may be referred to as a “high cycle life battery”). As discussed herein, a battery's battery cycle life refers to the quantity of charge and discharge cycles a battery can undergo before its charge capacity reduces below a threshold level (e.g., 80%). The exemplary low life cycle battery (i.e., a battery with a low battery cycle life) performs an exemplary energy storge function for renewable power sources, such as, photovoltaic (PV) or wind-driven generators, while the exemplary high life cycle battery (i.e., a battery with a higher battery cycle life—as compared to the battery with a lower battery cycle life) performs a peak saving function for when the system is under high load and/or renewable energy is not available. The system maximizes efficiency and reduces charge/discharge cycles by prioritizing distribution of renewable power to the load, then outputting power to the load from the high cycle life battery and then finally outputting power to the load from the low cycle life battery. The system also integrates non-renewable energy sources such as but not limited to diesel generators. The generator is configured to charge the high cycle life battery at a high cycle rate so as to maximize the load of the generator as it runs maximizing generator efficiency and avoiding wet stacking. Finally, the system includes methods (e.g., computer implemented algorithms) that preserve the life of the low cycle life batteries by restricting the cyclic discharge/recharge rate (of the low cycle life batteries) and/or enabling non-renewable power generation based on temperature, load, number of charge/discharge cycles and specific battery characteristics. As described herein, exemplary embodiments of the hybrid energy system 100 provide for a full hybrid battery (e.g., multiple battery capacities with multiple chemistries) that is compatible with multiple power (e.g., solar, wind, generator) combinations at a work site. As described herein, exemplary embodiments of the hybrid energy system 100 provide for 15+ years of battery life based on load/usage and a dual battery life cycle management system that extends the life of lower cycle life battery chemistries by utilizing a high cycle life battery to consume higher or transient loads and a lower cycle life battery for lower, more sustained loads. As discussed herein, in one embodiment, the high cycle life battery has a smaller capacity as compared to the capacity of the lower cycle life battery.

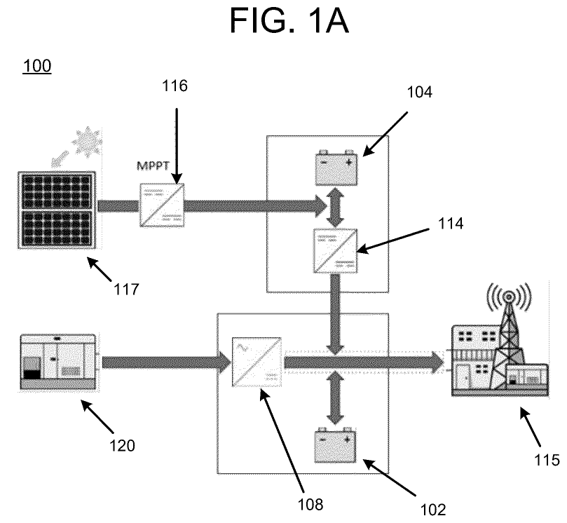

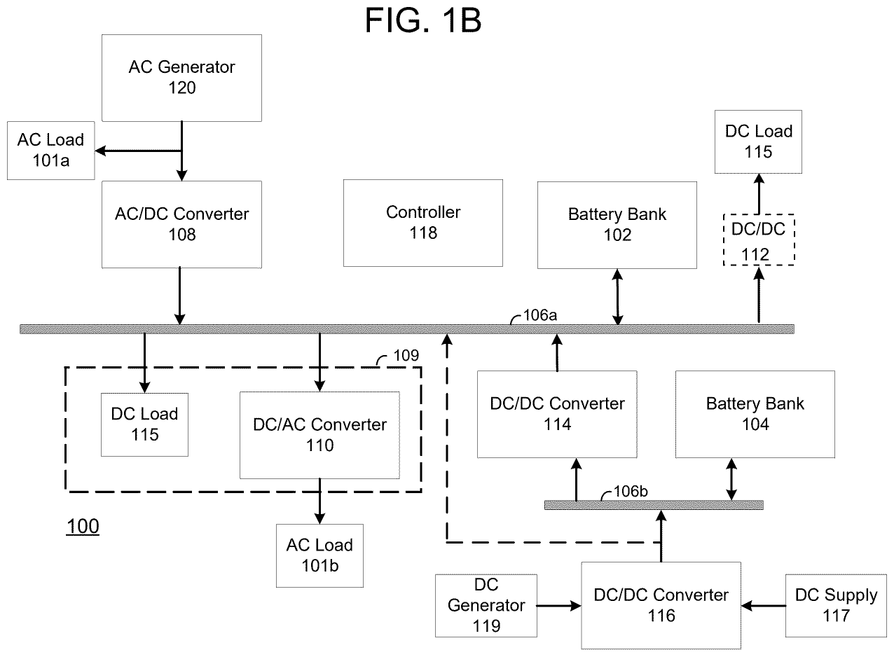

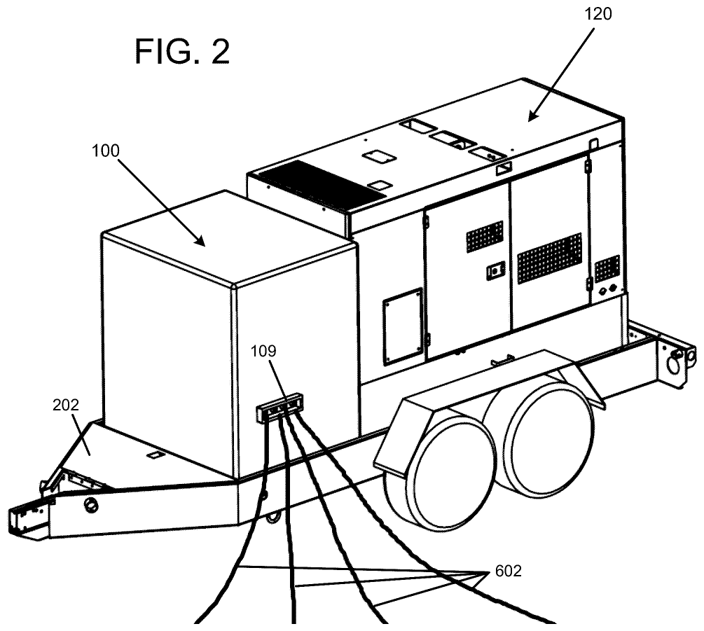

Referring to FIGS. 1A and 1B, an exemplary hybrid energy system 100 comprises a pair of different batteries 102, 104, each with different battery chemistries, including higher cycle life batteries 102 (to consume higher or transient loads) and lower cycle life batteries 104 (for lower, but more sustained loads). In one embodiment, the high cycle life batteries 102 have a lower charge capacity as compared to the charge capacity of the low cycle life batteries 104. By using the low cycle life batteries 104 at lower loads, the low cycle life battery 104 can be operated at a lower cycle rate, and thus result in cooler operations and a longer battery life (i.e., of the low cycle life battery 104). The hybrid energy system 100 can include a nonreplaceable higher cycle life battery 102 that can be placed low in the physical assembly. The battery 102 may be, for example, a lithium-titanium-oxide (LTO) battery. For example, the LTO battery 102 may be arranged within a trailer 202, such that the rest of the hybrid battery system 100 and the generator 120 are arranged above the battery 102 (see FIG. 2). The low cycle life battery 104 may be configured as a lithium-iron-phosphate (LFP) battery, however, other battery chemistries are also possible, such as lead acid batteries, etc. As discussed herein, the low cycle life battery 104 is arranged for user accessibility, replaceability, with an exemplary controlled charge/discharge rate providing a battery life of 10 to 15 years (by only cycling the battery once a day).

As illustrated in FIGS. 1A and 1B, an exemplary generator 120 is electrically coupled to an AC/DC converter 108 (that is, the generator 120 is an AC generator). The AC/DC converter 108 converts the AC output of the generator 120 to a selected DC voltage (e.g., 48 volts DC). The output of the AC/DC converter 108 is supplied to a battery 102. Thus, either the DC voltage output of the AC/DC converter 108 or the DC voltage output of the battery 102 is output on a DC bus 106a that is directly coupled to a DC load 115. In one embodiment, the DC output is an exemplary 48V DC. In another embodiment, the DC voltage from the DC bus 106 a is received by the DC load 115 via an optional DC/DC converter 112. Alternatively, as illustrated in FIG. 1B, the DC output (on the DC bus 106a) may be converted to an AC output (via DC/AC converter 110) for an AC load 101b. As also illustrated in FIG. 1B, alternatively, an AC load 101a could be directly coupled to the output of the generator 120. In one embodiment, the AC output of the generator 120 may be 208VAC, 480VAC or 240 VAC input power.

Referring to FIGS. 1A and 1B, a DC supply 117 may be coupled to a DC/DC converter 116. In one embodiment, the DC supply 117 is a photovoltaic power supply (i.e., a solar panel), and the DC/DC converter 116 is configured as a Maximum Power Point Tracker (MPPT) controller 116 for providing a consistent DC output from the photovoltaic power supply 117. While FIG. 1A illustrates the hybrid energy system 100 including the MMPT DC/DC converter 116, in an alternative embodiment, the MMPT DC/DC converter 116 may be coupled to the DC supply 117, such that the hybrid energy system 100 would include input connectors for coupling the external DC input 117 (e.g., a photovoltaic power source) to the battery 104 and the DC/DC converter 114. As discussed herein, alternatively, the external DC input 117 could come from a wind or water powered generator, or other similar renewable power generation devices. As illustrated in FIGS. 1A and 1B, the DC input from the MPPT DC/DC converter 116 and the battery 104 are coupled to a DC bus 106b which is coupled to a DC/DC converter 114. The DC output of the DC/DC converter 114 is coupled to the DC bus 106a. Thus, the DC output of the DC/DC converter 114, the DC output of the AC/DC converter 108, or the DC output of the battery 102, can be output via the DC bus 106a to the DC load 115. As illustrated in FIG. 1B, in one alternative embodiment, an optional DC generator 119 can be coupled to the DC/DC converter 116.

In one embodiment, an output voltage setpoint of the AC/DC converter 108 is less than the voltage output of the voltage output of the MPPT DC/DC converter 116. The maximum current of the DC voltage output from the AC/DC converter 108 varies. An exemplary output voltage setpoint of the MPPT DC/DC converter 116 is equal to a final charge voltage of the low cycle life battery 104. A maximum current of the DC voltage out of the MPPT DC/DC converter 116 varies. An exemplary input voltage setpoint of the DC/DC converter 114 is equal to a final discharge voltage of the low cycle life battery 104, while an exemplary output voltage setpoint for the DC/DC converter 114 is equal to a final charge voltage of the high cycle life battery 102. A maximum current of the DC voltage output from the DC/DC converter 114 varies.

In one embodiment, the hybrid energy system 100 is controlled by a controller 118, which is configured to control the charge and discharge cycles of the battery packs 102, 104. In one embodiment, the controller 118 is a computer system with a CPU configured to access and run an exemplary software program from a memory. The software program can include one or more software implemented methods, that when executed by the controller 118, will control the charge and discharge cycles of the battery packs 102, 104. The computer system 118 may be implemented as, for example, an embedded computer system, a minicomputer, or a microcomputer. The exemplary hybrid energy system 100 combines two charge/discharge cycles (as controlled by the controller 118), one being a 24-hour photovoltaic (PV) cycle and the other being a variable-length generator cycle. The 24-hour PV charge cycle starts when the PV power output (from the DC supply 117) exceeds the load demand (of the DC load 115). While in this charge cycle, the system 100 charges the batteries 102, 104, starting with the high cycle life battery (e.g., battery 102) and then continuing to charge the low cycle life battery (e.g., battery 104) once the high cycle life battery charge is complete. This charge cycle continues until the PV power no longer exceeds the load required by the DC load 115.

Once in the discharge cycle, the system 100 will power the DC load 115 using the low cycle life battery 104, then the high cycle life battery 102, once the low cycle life battery 104 is at a minimum state of charge. Once both batteries 102, 104 are at a minimum state of charge, the system enters the generator charge cycle by signaling (via the controller 118) the generator 120 to start and begin charging the high cycle life battery 102. Once the high cycle life battery 102 is charged the generator is turned off. The system 100 will remain in a generator charge/discharge cycle until PV power exceeds the load the following day (e.g., when the sun comes up the following day and the PV power output increases). The generator 120 is never used to charge the low cycle life batteries 104 thus restricting the low cycle life batteries 104 to 1 charge/discharge cycle per day. That is, the low cycle life batteries 104, when charged once per day, are recharged by the DC power output from the PV 117. It is understood that in this exemplary embodiment, the low cycle life battery 104 is only recharged by a photovoltaic power supply (which will not output power during the night).

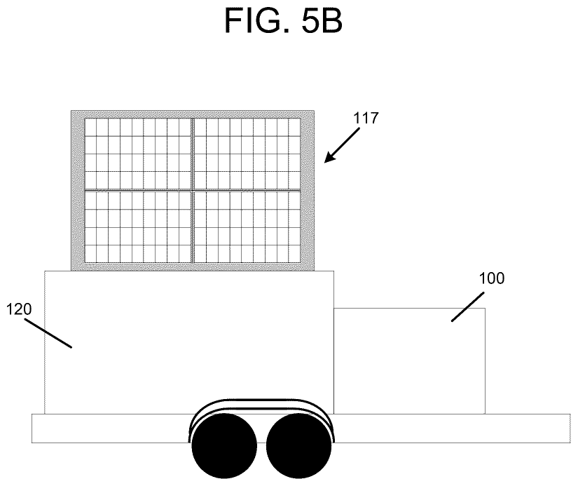

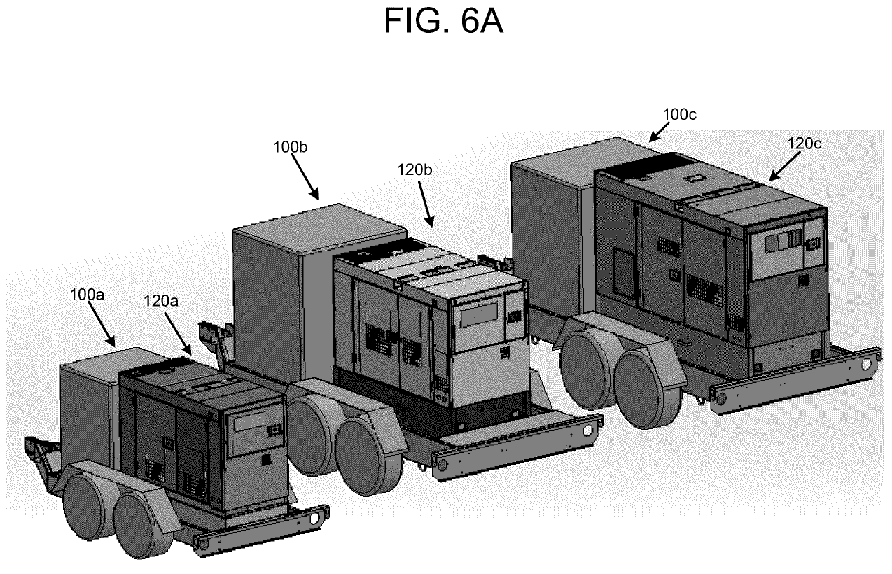

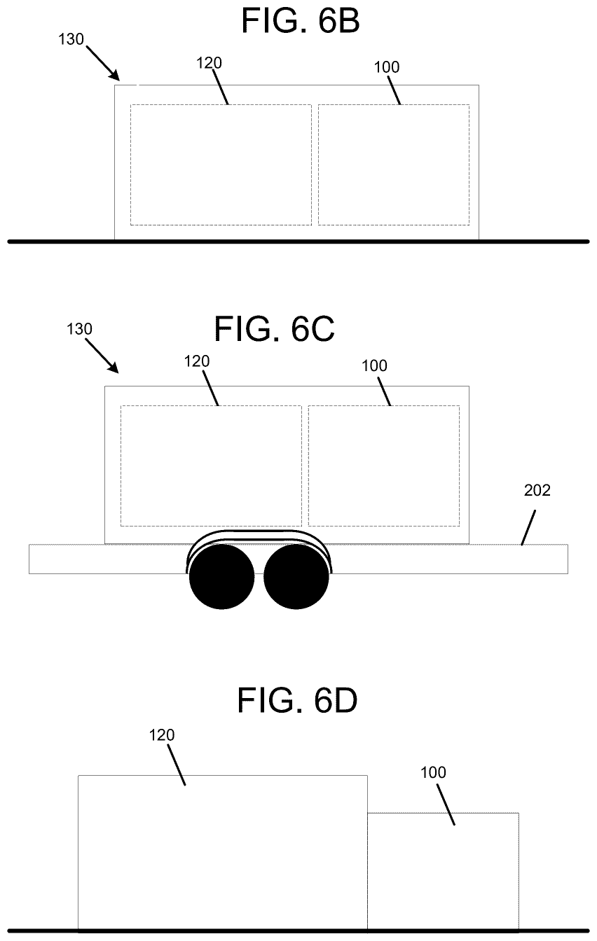

The controller 118 works to optimize genset operation, seamlessly switching between genset set power and stored energy. This can lead to reduced fuel consumption and lower associated greenhouse gas emissions. This helps to prevent issues from low load genset operation by running the generator 120 at a more efficient load point. Exemplary embodiments thus reduce generator runtime and thus extend the time between generator services. The exemplary embodiments require minimal maintenance and provide silent power (when power is supplied by the batteries 102, 104 and/or the PV 117). As discussed herein, the exemplary embodiments provide for an easy combination with standard generators 120 to provide a hybrid solution (see FIG. 6A).

In one embodiment, an exemplary hybrid energy system 100 is skid or trailer mounted at a work site (e.g., a telecommunications site) and provides reliable power to the work site equipment (e.g., telecommunications equipment) helping to significantly reduce fuel consumption. The hybrid energy system 100 may be configured to provide prime power at the work site (e.g., telecommunications equipment at a telecommunication site).

In one embodiment, the hybrid energy system 100 can function or respond as an Uninterruptible Power Supply (UPS) at a work site as it detects a power outage and reacts as a UPS. The hybrid energy system 100 can also be connected to a UPS for prime power applications.

In one embodiment, a user/operator can modify or control the operation of the hybrid energy system 100 via a control/display panel 302 (hereinafter referred to as a display panel 302). For example, the display panel 302 can include an exemplary IP67 HMI 5-inch display interface, capable of operating in a broad temperature range (e.g., ×30 C (−22 degrees F.) to 70 C (158 degrees F.). The display panel 302 may include a battery monitor displaying historical and instantaneous information, a load monitor displaying historical and instantaneous information, as well as a solar and maintenance charge status. The display panel 302 integrates with the renewable energy source's control panel (e.g., a control panel for the PV 117 can be integrated in the display panel 302). The display panel provides power metering and protective relaying. The display panel 302 may also provide text alarm/event descriptions, set points, inverter and battery monitoring, and is visible in all lighting conditions. In one embodiment, the display panel provides user graphics that provide a simple, user-friendly interface and navigation, with a home screen displaying status and real time power distribution. The controller 118 and/or display panel 302 provide for generator monitoring, remote control, and timer functions (e.g., up to 3 per day). In one embodiment, user commands via the display panel 302 are implemented by the controller 118.

The controller 118 of the hybrid energy system 100 is configured to provide or be compatible with telematics standards (e.g., bidirectional over the air updates, remote control, and remote monitoring). The controller 118 is also configured to provide automatic generator size detection. That is, the hybrid energy system 100 is agnostic to the type and size of the generator 120 provided to the system 100. As illustrated in FIG. 6A, the hybrid energy system 100 can be arranged with a variety of different hybrid energy systems 100a, 100b, and 100c, and with corresponding varying sizes of AC generators 120a, 120b, and 120c.

Referring to FIGS. 2, 3, 4, 6B, and 6D, the hybrid energy system 100 may be configured as a mobile energy system for movement to event areas where utility power is not available due to natural calamity and/or no power grid availability.

FIG. 2 illustrates an exemplary hybrid energy system 100 arranged on a trailer 202 alongside an exemplary AC generator 120. As illustrated in FIG. 2, the hybrid energy system 100 includes a load output interface 109 with a plurality of power cords 602 running to loads (e.g., DC loads 115 and/or AC loads 101a, b).

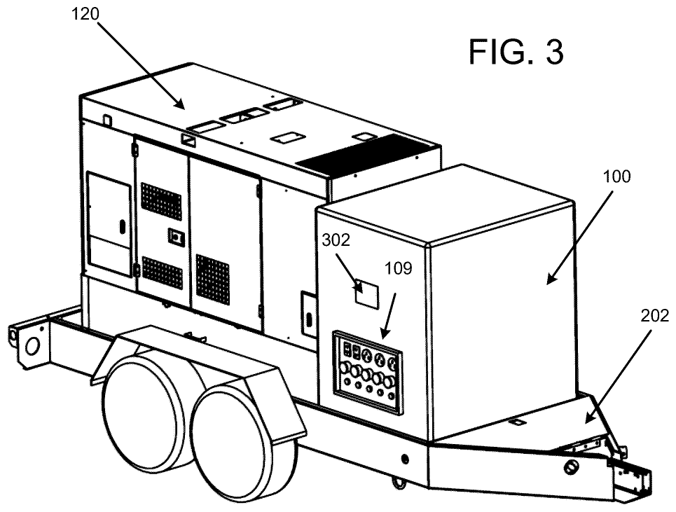

FIG. 3 illustrates an opposite side of the hybrid energy system 100 and AC generator 120 of FIG. 2. As illustrated in FIG. 3, the hybrid energy system 100 includes the load output interface 109 with outlets to DC loads 115 and/or AC loads 101a, b. FIG. 3 also illustrates an exemplary programmable control panel 302 for interfacing with the hybrid energy system 100. For example, the control panel 302 allows user interaction with the controller 118 of the hybrid energy system 100. The control panel 302 includes a programmable graphical user interface (e.g., a touch-responsive panel) for inputting user feedback. The control panel 302 displays basic generator information and operational status, which can be monitored and reported. The control panel 302 also displays basic battery and converter/inverter information from the hybrid energy system 100. The control panel 302 also provides for control of the charging cycles and discharge cycles of the dual battery system (e.g., battery bank 102 and battery bank 104).

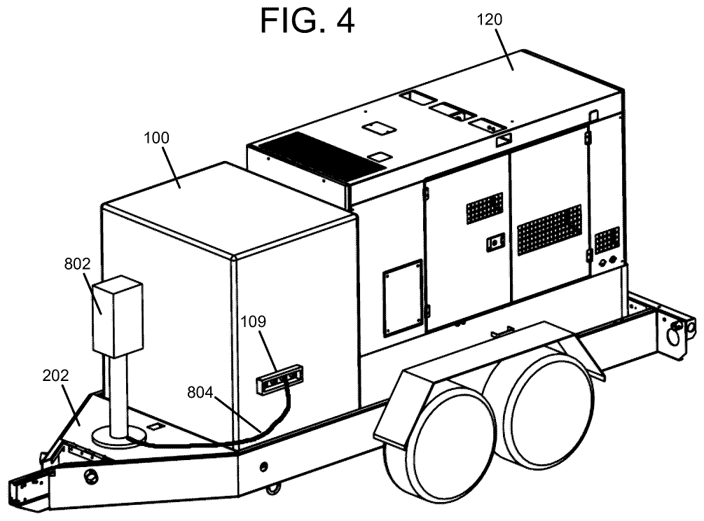

FIG. 4 illustrates the hybrid energy system 100 and AC generator 120 of FIG. 2 with the addition of an exemplary DC outlet box 802. As illustrated in FIG. 4, the DC outlet box 802 is electrically coupled to the load output interface 109 via an exemplary cable 804.

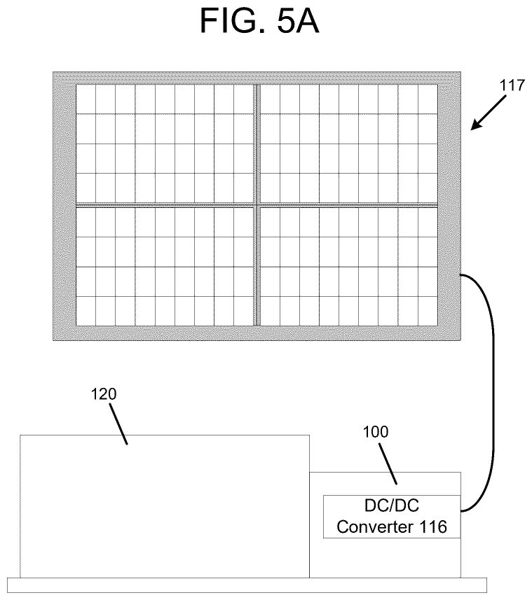

In FIG. 5A, an exemplary external power supply, such as a renewable energy source (e.g., a photovoltaic power source) 117 is coupled to the DC/DC converter 116. As discussed herein, alternatively, the renewable energy source 117 can include wind-driven turbines, fuel cell technology, and other energy sources. In FIG. 5B, an exemplary on-board solar panel 117 provides power to a load (e.g., DC load 115) and for charging the batteries 102, 104 of the hybrid energy system 100 when loads are below the output of the solar panels 117.

As illustrated in FIG. 6A, exemplary embodiments may be sized to fit a desired operational environment and AC and/or DC power load needs. In FIG. 6B, a hybrid energy system 100 and a generator 120 are arranged within a unitary body 130. Such an arrangement 130 may be positioned upon a trailer 202 (see FIG. 6C) or configured as free-standing or stationary (FIG. 6D). Such coupled versions (with separate enclosures for the hybrid energy system 100 and the generator 120) may also be arranged as free-standing or stationary. The unitary body arrangement 130 may be substituted for any of the embodiments with generators 120 and hybrid energy systems 100 arranged in separate housings. For example, a combination of unitary bodies 130 (each housing a generator100/hybrid energy system 120 arrangement) could be used together with one or more generators 120 and hybrid energy systems 100 in separate housings.

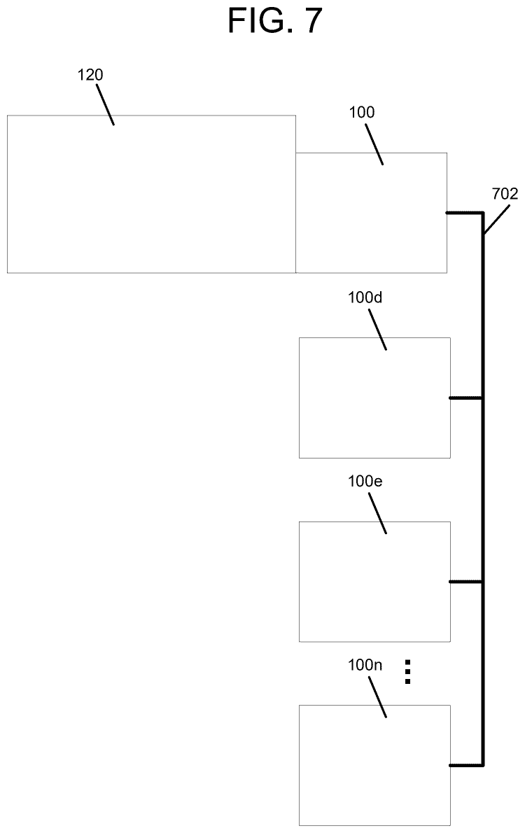

Referring to FIG. 7, the hybrid energy system 100 may be configured for multiple deployment for large high-density work sites (e.g., A cell network over several thousand square feet) that can handle many simultaneous connections within short time periods (e.g., within seconds). Thus, a hybrid energy system 100 may be paired with a second hybrid energy system 100d or a plurality of hybrid energy systems 100d-100n. In one embodiment, one or more of the hybrid energy systems 100, 100d-100n may include a PV 117 providing DC power. The output of each of the plurality of hybrid energy systems 100, 100d-100d are tied together using a common bus 702 communicatively coupled to at least two or more of the hybrid energy systems 100, 100d-100n, such that the plurality of hybrid energy systems 100, 100d-100n can output in parallel DC power. Alternatively, one or more of the hybrid energy systems 100, 100d-100n could output AC power as well (e.g., both three-phase and singe-phase AC power). In a further embodiment, each of the hybrid energy systems 100d-100n is paired with an associated generator 120, allowing for additional flexibility with multiple generators 120 selectively used to power a load 115 or recharge a battery bank 102 in an own hybrid energy system 100 or another parallel-configured hybrid energy system 100d-100n.

While the control panel 302 (see FIG. 3) displays hybrid energy system voltage outputs and operating parameters, in an aspect of the embodiments discussed herein, output voltage and operating parameters can be selected from the control panel 302. The selected voltage can also be fine-tuned and adjusted up or down by, for example, up to 10% by the user via the control panel 302. Such adjustment may be necessary when the electrical device drawing power from the hybrid energy system 100 is a distance from the hybrid energy system 100 and experiencing a resulting voltage drop.

Thus, the exemplary embodiments discussed herein improve the efficiency of a diesel generator by running it at its optimal load and reducing its run time by storing unused generated power to a plurality of different batteries (a high cycle life battery (with a long battery cycle life) and a low cycle life battery (with a short battery cycle life). The high cycle life battery has a smaller charge capacity as compared to the charge capacity of the low cycle life battery. The low cycle life battery is recharged once each day using a renewable energy source, such as a photovoltaic source, while the high cycle life battery is recharged as needed (when there is no renewable energy source) by an engine/generator. The hybrid energy system powers a load while the engine/generator is powered down. The power output from the engine/generator is converted to DC power by an AC/DC converter. The DC power is output by the hybrid energy system directly to a DC load. The hybrid energy system minimizes generator run hours, improve fuel consumption, and reduces emissions compared to a conventional generator setup to power a load. The hybrid energy system further improves the life of low cycle life batteries by limiting them to a single cycle each day.

Changes and modifications in the specifically described embodiments can be carried out without departing from the principles of the present invention which is intended to be limited only by the scope of the appended claims, as interpreted according to the principles of patent law including the doctrine of equivalents.

1. A hybrid energy system configured to carry a power load for a generator configured to output a first AC signal, the hybrid energy system comprising:
a controller configured to control the charging and discharging of the hybrid energy system;
an energy source configured to output a first DC signal to a first DC bus;
an AC/DC converter configured to receive and convert the first AC signal from the generator into a second DC signal, wherein the AC/DC converter is configured to output the second DC signal to a second DC bus;
a plurality of battery banks comprising a first battery bank and a second battery bank, wherein the first battery bank is configured to selectively output a third DC signal, wherein the second battery bank is configured to selectively output a fourth DC signal, and wherein the first battery bank is configured to output the third DC signal to the first DC bus;
wherein, when the generator is not outputting the first AC signal, the controller is configured to selectively control the first battery bank and the second battery bank, such that at least one of the first battery bank and the second battery bank outputs the third DC signal and the fourth DC signal to a load, respectively; and
wherein the controller is configured to control the recharging of the second battery bank selectively using at least one of the energy source and the generator, and wherein the controller is further operable to control the recharging of the first battery bank selectively using the energy source.

2. The hybrid energy system of claim 1, wherein the controller is configured to control the recharging of the first battery bank such that the first battery bank is recharged by the energy source only once in a twenty-four-hour period.

3. The hybrid energy system of claim 1, wherein the energy source is a renewable energy source.

4. The hybrid energy system of claim 3, wherein the energy source comprises at least one of a photovoltaic generator, a wind-driven generator, and a water-driven generator.

5. The hybrid energy system of claim 1, wherein the first battery bank is a battery with a short battery cycle life, and wherein the second battery bank is a battery with a long battery cycle life, such that the battery cycle life of the first battery is shorter than the battery cycle life of the second battery.

6. The hybrid energy system of claim 5, wherein the controller is configured to shut down the generator and power the load with the second battery bank whenever a charge level of the second battery bank is above a charge threshold level.

7. The hybrid energy system of claim 5, wherein the controller is configured to shut down the generator and power the load with the first battery bank while a charge level of the first battery bank is above a charge threshold level.

8. The hybrid energy system of claim 5, wherein the first battery bank comprises a charge capacity that is higher than a charge capacity of the second battery bank.

9. The hybrid energy system of claim 5, wherein the first battery bank is configured to power a smaller power load level as compared to the second battery bank.

10. The hybrid energy system of claim 1, wherein the controller is operable to control the recharging of the first battery bank and the second battery bank using (i) an energy source mode wherein while the generator is powered down and the load is powered by the energy source, when the energy source is outputting more power than required by the load, the energy source also recharges the first battery bank once in a given period of time and then recharges the second battery bank thereafter, and (ii) a generator mode wherein while powering the load with the generator, when the generator is outputting more power than required by the load, the generator also recharges the second battery bank.

11. A hybrid energy system configured to carry a power load for a generator configured to output a first AC signal, the hybrid energy system comprising:
an energy source configured to output a first DC signal to a first DC/DC converter, which is configured to output a second DC signal to a first DC bus, wherein the first DC bus is coupled to a first battery bank and a second DC/DC converter, and wherein the first battery bank is configured to selectively output a fourth DC signal;
an AC/DC converter configured to receive and convert the first AC signal from the generator into a third DC signal, wherein the AC/DC converter is configured to output the third DC signal to a second DC bus, wherein the second DC/DC converter and a second battery bank are coupled to the second DC bus, wherein the second DC bus is coupled to a load, and wherein the second battery bank is configured to selectively output a fifth DC signal; and
a controller configured to selectively control the first battery bank and the second battery bank, such that when the generator is not outputting the first AC signal, at least one of the first battery bank and the second battery bank outputs the fourth DC signal and the fifth DC signal to the load, respectively;
wherein the controller is further configured to control the recharging of the second battery bank selectively using at least one of the energy source and the generator, and wherein the controller is further configured to control the recharging of the first battery bank such that the first battery bank is only recharged once during a given time period.

12. The hybrid energy system of claim 11, wherein the controller is configured to control the recharging of the first battery bank such that the first battery bank is selectively recharged by the energy source, and wherein the given time period is a twenty-four hour period.

13. The hybrid energy system of claim 11, wherein the energy source is a renewable energy source.

14. The hybrid energy system of claim 13, wherein the energy source comprises at least one of a photovoltaic generator, a wind-driven generator, and a water-driven generator.

15. The hybrid energy system of claim 11, wherein the first battery bank is a battery with a short battery cycle life, and wherein the second battery bank is a battery with a long battery cycle life, such that the battery cycle life of the first battery is shorter than the battery cycle life of the second battery.

16. The hybrid energy system of claim 15, wherein the controller is configured to shut down the generator and power the load with the second battery bank whenever a charge level of the second battery bank is above a charge threshold level.

17. The hybrid energy system of claim 15, wherein the controller is configured to shut down the generator and power the load with the first battery bank while a charge level of the first battery bank is above a charge threshold level.

18. The hybrid energy system of claim 15, wherein the first battery bank comprises a charge capacity that is higher than a charge capacity of the second battery bank.

19. The hybrid energy system of claim 15, wherein the first battery bank is configured to power a smaller power load level as compared to the second battery bank.

20. The hybrid energy system of claim 11, wherein the controller is operable to control the recharging of the first battery bank and the second battery bank using (i) an energy source mode wherein while the generator is powered down and the load is powered by the energy source, when the energy source is outputting more power than required by the load, the energy source also recharges the first battery bank once in a given period of time and then recharges the second battery bank thereafter, and (ii) a generator mode wherein while powering the load with the generator, when the generator is outputting more power than required by the load, the generator also recharges the second battery bank.
